(19) United States
(12) Patent Application Publication
(10) Pub. No.: US 2016/0153563 A1
(43) Pub. Date: Jun. 2, 2016

(54) SEAL AND A METHOD OF FORMING THE SAME

(71) Applicant: AKTIEBOLAGET SKF

(72) Inventor: Shiva Bissoon, Toronto (CA)

(21) Appl. No.: 14/556,201

(22) Filed: Nov. 30, 2014

(51) Int. Cl. F16J 15/32

(52) U.S. Cl. CPC F16J 15/3272; F16J 15/3204; F16J 15/328

(57) ABSTRACT

A seal of the present invention is used in a fluid seal assembly (the assembly) disposed between an outer surface, i.e. engine block or any other part that requires application of the assembly and a rotatable member, such as, for example a shaft, wherein the assembly circumscribes the shaft and lubricated the shaft and the same rotates around the axis. The assembly includes an intermediate member positioned on the shaft and frictionally engaging the seal. The seal presents a split seal design defining mechanical connectors defined at each terminal end of the seal to provide locking engagement as the seal is formed. A method of forming the seal is provided.

### FIELD OF THE INVENTION

The present invention relates to seal assemblies, and more particularly to annular seal rings for use in controlling fluid passage between a stationary surface and a moving surface.

### BACKGROUND OF THE INVENTION

Fluid seals assemblies of various types are used in numerous applications including and not limited to sealing vehicular engine crankshafts, transmission shafts, bearing lubrication systems, compressor shaft support assemblies, and the like. The typical fluid seal assembly is designed to retain and seal oil or grease in a predetermined location for lubricating the shaft and to prevent ingress of environmental contaminants. The art is replete with various prior art references teaching numerous seals designs adaptable to retain and seal oil or grease in a predetermined location for lubricating the shaft. The typical fluid seal assembly includes a casing unit, a flexible sealing or seal ring having a sealing lip adapted to engage against a sealing surface of a relatively rotatable member, such as the shaft. The seal rings are widely used in sealing applications where fluid containment is a desirable aim. The flexible sealing ring includes a body portion extending to an annular flex portion of reduced cross-sectional thickness bonded to the metal case member and located intermediate the seal lip and metal case. The seal rings of various non-metallic materials such as polytetraflouroethylene (PTFE) as well as elastomeric materials have been developed and widely used as seals where annular groove equipped shafts are supported in adjacent housings.

Currently, all seals have an annular configuration and are slid over the free end of a shaft to locate within the housing. A problem with this arrangement is that it is difficult to gain access to the bearings for inspection or cleaning as the seal is not easily removed. Thus, the housing has frequently to be dismantled and the shaft removed therefrom before the seal can be removed or replaced. This is both inconvenient and time consuming.

In order to position these seal rings into the annular grooves it has been found necessary to split the ring using a step cut junction to allow the ring to be expanded over the surface having the annular groove. The step cut rings have the disadvantage that when they are spread and reassembled the adjoining ends of the rings may not retain their original close relationship thus resulting in a seal ring that has a larger diameter than desired. A second type of seal ring is an expansion type where the ring is cut in a specific way leaving a flexible membrane that does not sever the continuity of the ring but does allow temporary diameter changes during installation. The disadvantage of these seal rings are that the ring cannot be opened more than a nominal amount without damage to the flexible membrane.

The prior art is replete with various other types of the seal rings, such as a seal ring incorporating an interlocking snap-on fastening system and having a rectangular body defined by a top surface, an interior surface, a bottom surface and an exterior surface, as taught by U.S. Pat. No. 4,533,149 to Vater et. al. The interlocking and essentially clearance-free fastening system is formed through the process of making a series of die cuts into a preformed PTFE (or other alternative seal ring material) seal ring that is a continuous band. The first die cut is made from the outside surface of the seal ring toward the inside surface. It is a single cut made with a die having a shape shown as a transverse die cut by the solid line. This transverse die cut forms interlocking male or tongue and female or groove elements, the interior flat base and the interior floor of the radially interlocking wedge portion. The second die cut is a top surface transverse die cut that is formed by a cutting die being forced through the top surface of the seal ring and into the interior of the seal ring for a predetermined depth. This second die cut is a non-radial die cut extending from an inboard intersection of the interior surface and the top surface to a reversal point and then reversing its direction and extending in an opposite or angular with direction from the reversal point to an outboard intersection of the exterior surface and the top surface. The depth of the second die cut is uniform for the length of the cut and extends from the top surface to the first die cut. The die cutting operation and configuration of the interlocking male or tongue and the female or groove elements is very complicated.

Another prior art reference, namely U.S. Pat. No. 5,967,525 to Sandgren et al., teaches a seal ring, which has a split dividing seal ring into at least two sections. The seal ring includes an outer circumferential groove and an outer circumferential recess, wherein the outer circumferential groove has an axial width greater than the axial width of clamp ring to thereby permit a general orientation or positioning of clamp ring about the outer circumference of the seal ring.

In addition, the outer circumferential recess has sufficient dimension to receive a snap ring while nevertheless permitting assembly of clamp ring over the snap ring. When assembled, the seal ring presents a rotating sealing surface to non-rotating seal ring so as to form an effective fluid seal of recess within stationary housing. The seal ring design taught by the U.S. Pat. No. 5,967,525 to Sandgren et al. is complicated, required multiple parts to be manufactured and redundant assembly steps thereby providing a product that is not cost effective and time consuming when it comes to assembly, installation or service. Other prior art seal ring present a standard straight cut that allows a gap during assembly leaving uncertainty on the width of the gap.

There is a need for improved connection design between terminal ends of the seal ring that will allow end user to assemble a split seal without having a gap therebetween, reduce leakage on split type seals, and prevent spreading motion between the terminal ends when the seal ring is assembled.

Hence, there is also a need for an improved fluid seal and methods to solve problems associated with prior art designs such as static leakage of oil, constant wear and tear and replacement of parts that negatively impact lifecycle of the fluid seals.

The inventive concept as set forth further below improves the aforementioned prior art sleeve designs.

### SUMMARY OF THE INVENTION

A split seal of the present invention is used in fluid seal assembly (the assembly) and has numerous applications including and not limited to sealing vehicular engine crankshafts, transmission shafts, bearing lubrication systems, compressor shaft support assemblies, and the like. The assembly is disposed between an outer object, i.e. a housing or an engine block or any other part that requires application of the assembly and a rotatable member, such as, for example a shaft, wherein the assembly circumscribes the shaft and lubricated the shaft as the same rotates around the axis.

The split seal includes a body having terminal ends, an outer surface extending generally parallel to an axis of the shaft and facing the outer object, a first flat surface and a second flat surface spaced by the outer surface and extending radially and generally perpendicular to the axis of the shaft, an inner surface extending in parallel to the outer surface. The second flat surface extends beyond the first flat surface to a neck portion with further an extension element extending generally parallel to the shaft. The extension element presents an annular groove to receive a spring, a primary lip and a secondary lip to engage the shaft. The terminal ends present a mechanical connection formed as a dovetail configuration with a female connector formed at one of the terminal ends and a male connector formed at another terminal end. The split seal is formed from a polyurethane material, an elastomeric material and PTFE based materials also.

A method of forming the split seal is disclosed. Billets are formed during the injection molding process. Billets of material are placed inside a seal forming machine, such as for example, a Sealjet® machine, and an annular seal is machined with a particular profile. Profile of the seal is input into the special program “Ecocalc” cooperable with a controller or the like. One piece seal cut in the desired profile by the machine. After the seal is manufactured, the cutting tool designed to form a dovetail is used to cut the seal with the dovetail connection. Another method of producing the seal can be from extrusion. Based on seal design and final product dimensions and configurations, a profile of the desired seal is input into the controller operably connected to the seal forming machine and the cutting tool designed to form dovetail and other cuts in the strand of the body of the seal formed by the extruder. One piece seal cut in the desired profile is formed.

An advantage of the present invention is to provide a seal for fluid seal assembly that will solve problems associated with prior art designs such as static leakage of oil, constant wear and tear and replacement of parts that negatively impact lifecycle of the fluid seals.

Another advantage of the present invention is to provide the split seal presenting improved connection design between terminal ends of the split seal allowing end users to assemble the split seal without having a gap therebetween.

Still another advantage of the present invention is to provide the split seal presenting improved connection design between terminal ends of the split seal to reduce leakage inside the fluid seal assembly and prevent spreading motion between the terminal ends when the split seal is assembled.

Still another advantage of the present invention is to provide the split seal presenting improved connection design between terminal ends of the split seal wherein the improved connection presents a dovetail cut formed through the cross section of the split seal.

Still another advantage of the present invention is to provide the split seal presenting improved connection design between terminal ends of the split seal wherein the improved connection presents a dovetail cut formed through the cross section of the split seal without impacting sealing purposes and properties of primary and secondary lips of the split seal.

Other advantages and meritorious features of this invention will be more fully understood from the following description of the preferred embodiment, the appended claims, and the drawings; a brief description of which follows.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 illustrates a schematic view of a production process to manufacture a seal of the present invention;

FIG. 1A illustrates a schematic view of an alternative embodiment of a production process to manufacture a seal through extrusion process;

FIG. 2 illustrates a cross sectional view of the seal;

FIG. 3 illustrates a cross sectional view of the seal positioned between a shaft and the outer object;

FIG. 4 illustrates a perspective view of the seal with split terminal ends defining a dovetail connection presenting a male connector at one terminal end and a female connector at another terminal end;

FIG. 5 illustrates a front view of the seal;

FIG. 6 illustrates a front view of the seal positioned on the shaft and showing a dovetail connection;

FIGS. 7 through 9 illustrates several partial views of a top surface of the seal defining the dovetail connection;

FIG. 10 illustrates a fragmental view of alternative embodiment of the dovetail connector;

FIG. 11 illustrates a fragmental view of a second alternative embodiment of the dovetail connector;

FIG. 12 illustrates a schematic view of the method of forming the seal of the present invention; and

FIG. 13 illustrates a schematic view of an alternative method of forming the seal of the present invention.

### DETAILED DESCRIPTION OF THE INVENTION

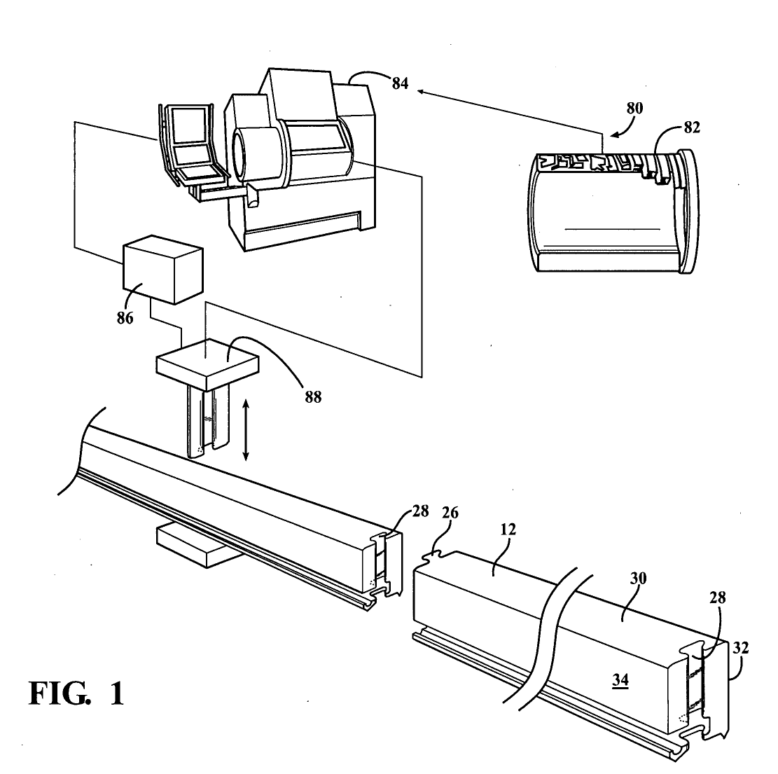

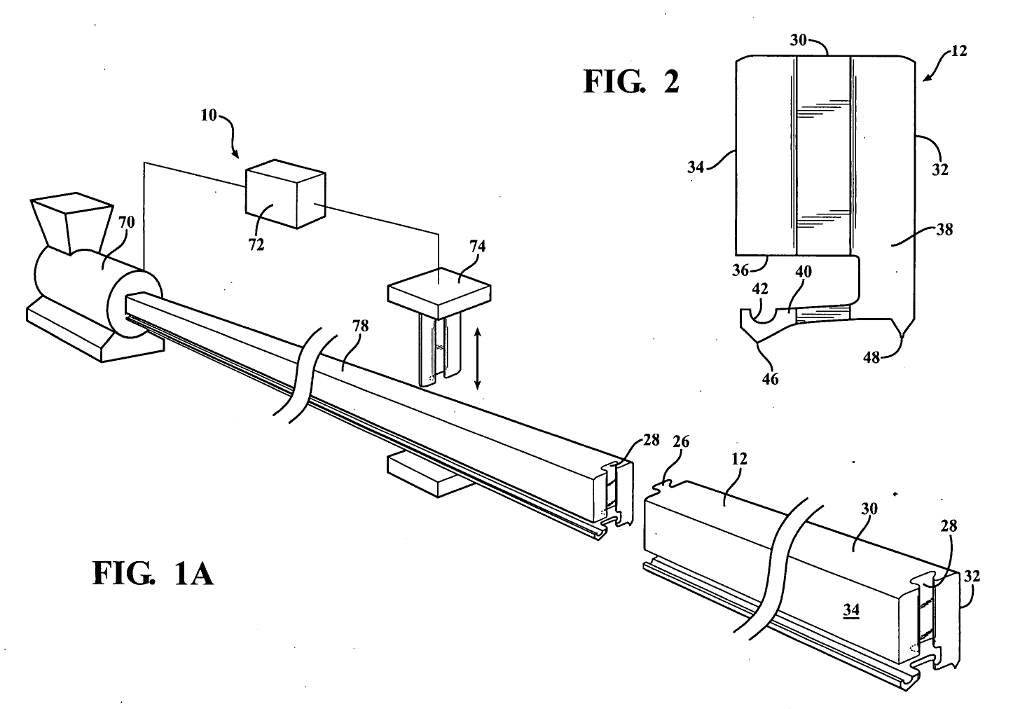

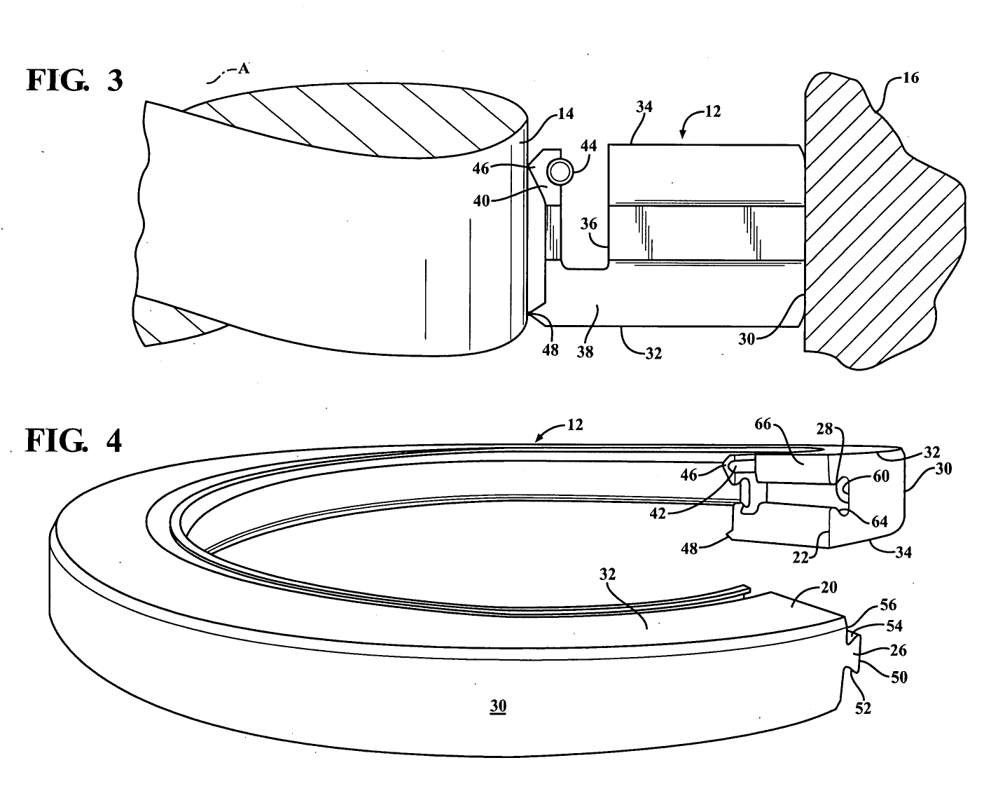

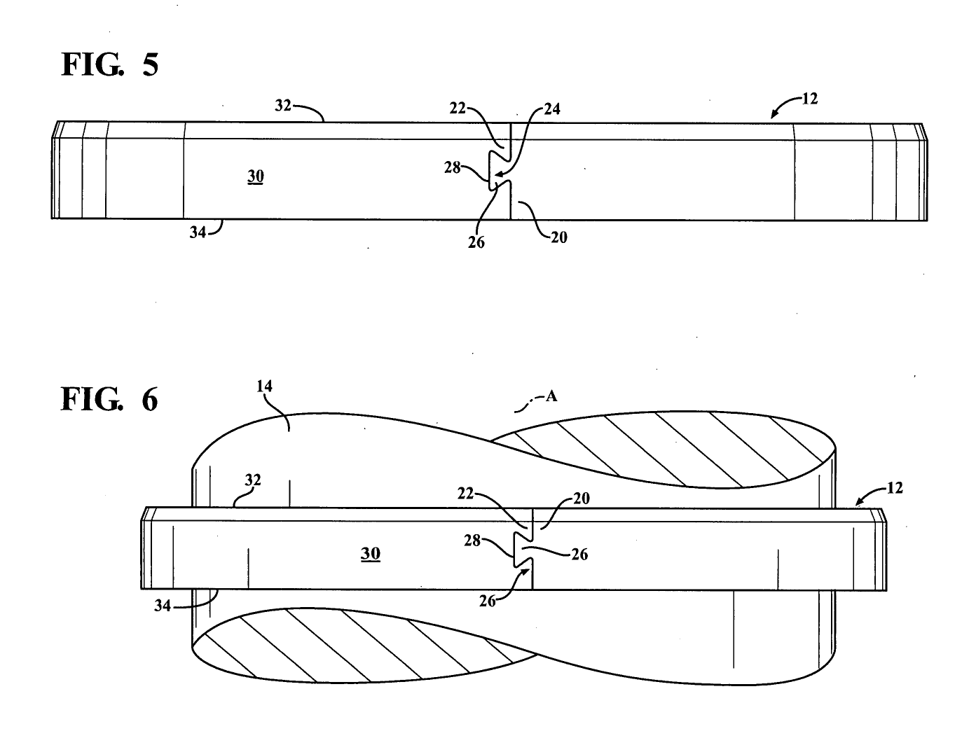

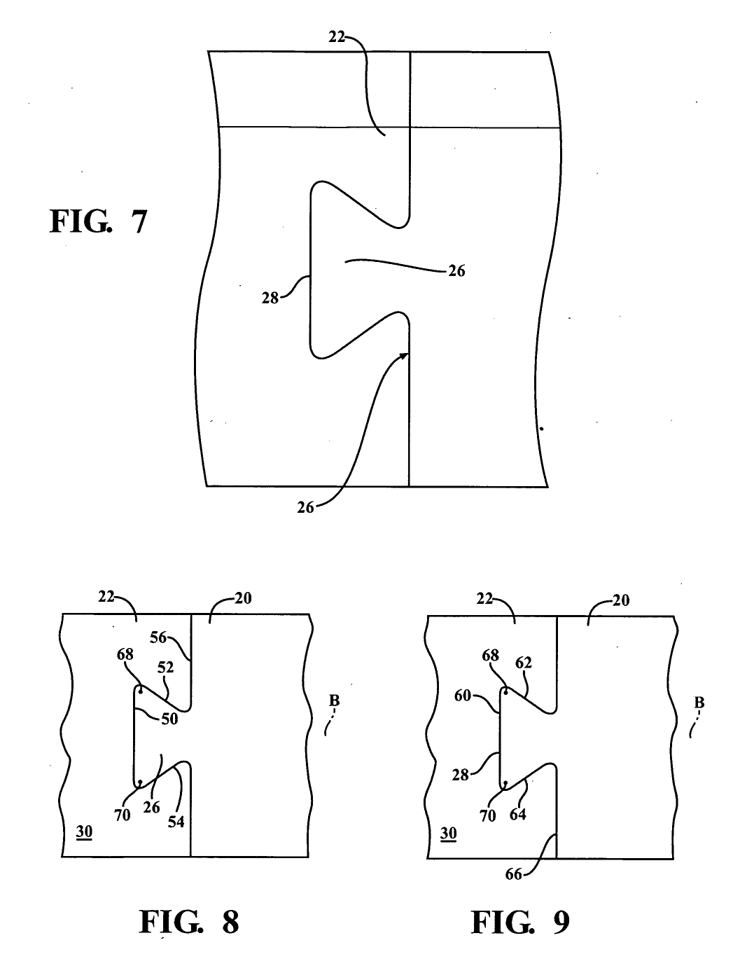

Referring to the FIGS. 1 through 13, wherein like numerals indicate like or corresponding parts throughout the several views, FIG. 1 illustrates a production line to manufacture a seal of the present invention, generally shown at 10. FIG. 2 illustrates a cross sectional view of a split seal, generally shown at 12. FIG. 3 illustrates another cross sectional view of the seal 12 positioned between a shaft 14 and an outer object 16. FIGS. 4 and 5 illustrates a front view and a perspective view, respectively, of the seal 12 with split terminal ends 20, 22 defining a dovetail connection, generally indicated at 24, presenting a male connector 26 at one terminal end 20 and a female connector 28 at another terminal end 22. FIG. 6 illustrates another front view of the seal 12 positioned on the shaft and showing the mechanical connection 26 in the form of a “dovetail”, i.e. the dovetail connection. FIGS. 7 through 9 illustrate a partial view of a top surface of the seal 12 defining the dovetail connection 26.

Alluding to the above, the seal 12, i.e. the split seal of the present invention is used in fluid seals assembly of the present invention and has numerous applications including and not limited to sealing vehicular engine crankshafts, transmission shafts, bearing lubrication systems, compressor shaft support assemblies, and the like. The assembly is disposed between an outer object, i.e. a housing or an engine block 16 or any other part that requires application of the assembly and a rotatable member, such as, for example the shaft 14, wherein the assembly circumscribes the shaft 14 and lubricated the shaft 14 as the same rotates around the axis A.

The split seal 12 includes a body having the aforementioned terminal ends 20, 22, an outer surface 30, extending generally parallel to the axis A of the shaft 14 and facing the outer object 16, a first flat surface 32 and a second flat surface 34 spaced by the outer surface 30 and extending radially and generally perpendicular to the axis A of the shaft 14, an inner surface 36 extending in parallel to the outer surface 30. The first flat surface 32 extends beyond the second flat surface 34 to a neck portion 38 with further an extension element 40 extending generally parallel to the shaft 14. The extension element 40 presents an annular groove 42 to receive a spring 44, a primary lip 46 and a secondary lip 48 to engage the shaft 14. The terminal ends 20, 22 present the mechanical connection 26 formed in a dovetail configuration with the male connector 26 formed at one terminal end 20 and the female connector 28 formed at another terminal end 22. The split seal 12 is formed from a polyurethane material, an elastomeric material and polytetrafluoroethylene (PTFE) based materials also. Those skilled in the art will appreciate that other suitable materials including and not limited to rubber, silicone, polyacrylic, fluoroelastomer, ethylene acrylic, hydrogenated nitrile or nitrile elastomer. The sleeve 44 may also be formed from other materials such as, for example, polytetrafluoroethylene (PTFE) without limiting the scope of the present invention.

Referring back to FIGS. 2, 4, 8, and 9, the dove tail connection 24 will be discussed in details. The male connector 26 extends from the outer surface 30, extending generally parallel to the axis A of the shaft 14 to the inner surface 36. As best illustrated in FIGS. 5 and 8, the male connector 26 includes a front wall 50 extending beyond a front surface 56 and a pair of inclined side walls 52, 54 diverging from the front surface 56 to the front wall 50 to define a neck 58 being shorter than the front wall 50.

As best illustrated in FIGS. 5 and 9, the female connector 28 is formed as a groove to receive the male connector 26. The female connector 28 extends from the outer surface 30, extending generally parallel to the axis A of the shaft 14 to the inner surface 36 to receive the male connector 26. The female connector 28 includes a bottom wall 60 to mate with the front wall 50 and a pair of inclined side walls 62, 64 converging from the bottom wall 60 to mate with inclined walls 52, 54 of the male connector 26.

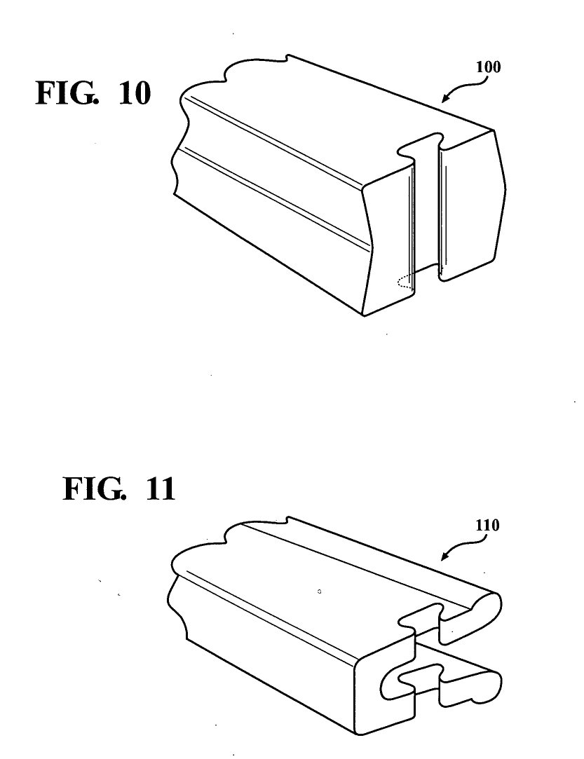

As the male connector is engagingly locked with the female connector 28, to locking points, generally indicated at 68 and 70 in FIGS. 8 and 9, are formed thereby preventing any disengagement from one another along axis B. The dovetail connection 24 forms an interlocking fastening system connecting the terminal ends 20, 22 thereby providing a detachable locking arrangement thereof in both radial and longitudinal directions, preventing radial displacement and longitudinal uncoupling thereof. FIG. 10 illustrates a fragmental view of alternative embodiment of the dovetail connector of the seal, generally shown at 100. FIG. 11 illustrates a fragmental view of a second alternative embodiment of the dovetail connector of the seal, generally shown at 110.

Referring back to FIG. 1A, an alternative embodiment of the production process is generally shown at 10. Billets of material are placed inside an extruder 70. Based on seal design and final product dimensions and configurations, a profile of the desired seal is input into a controller 72 operably connected to the extruder 70 and a cutting tool 74 designed to form “dovetailed” and other cuts in a strand 78 of the body of the seal formed by the extruder 70. One piece seal cut in the desired profile is formed. The cutting tool 74 tool is created to establish this “dovetail” profile cut, which ensures two lock-in points 68, 70, when assembled. The seal 12 is first machined to create a one piece seal.

After the sealing profile is created, the cutting tool 74 is then used in a second operation to create the “dovetail” cut. The cutting tool 74 can be adapted as hand operated tool and/or automatic tool is number of the seals 12 with predetermined profile are required to be formed.

Referring back to FIG. 1, the production line to manufacture the seal 12 of the present invention is generally shown at 80. Billets of material 82 are placed inside a seal manufacturing machine such as a sealjet 84 or the like. Based on seal design and final product dimensions and configurations, a profile of the desired seal is input into a controller 86 operably connected to the sealjet machine 84 and a cutting tool 88 designed to form “dovetailed” and other cuts in the strand 78 of the body of the seal formed by the sealjet machine 84. One piece seal cut in the desired profile is formed. The cutting tool 88 is created to establish this “dovetail” profile cut, which ensures two lock-in points 68, 70, when assembled. The seal 12 is first machined to create a one piece seal.

After the seal is created, the cutting tool 88 is then used in a second operation to create the “dovetail” cut. The cutting tool 88 can be adapted as hand operated tool and/or automatic tool is number of the seals 12 with predetermined profile are required to be formed.

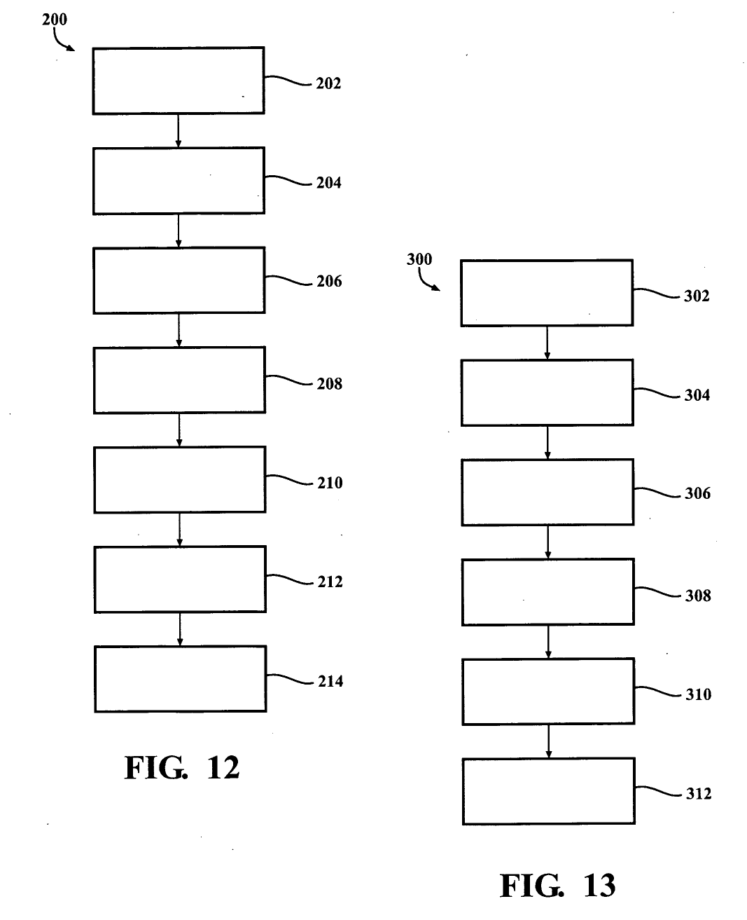

FIG. 12 is a schematic view of the method of forming the seal of the present invention, generally shown at 200 to be discussed further below. As shown at 202, the controller 86, the seal forming machine 84, and the cutting tool 88 are electronically communicated with one another. As shown at 204, a billet 82 is placing into the seal forming machine 84 to form the seal 12 with predetermined and programmed dimensions and configurations send from the controller 86 to the seal forming machine 84, as shown at 206. As shown at 208, machining the billet 82 is initiated at the seal forming machine 84 to have a cross section of the body of the seal with the outer surface 30, the first flat surface 32, the second flat surface 34 spaced by the outer surface 30, and the inner surface 36 extending in parallel to the outer surface 30.

Alluding to the above, the step of cutting the seal 12 by the cutting tool 88 is shown at 210, whereby the cutting profile extends through the outer surface 30 to the inner surface 36 to form the dovetail mechanical cut profile 24 formed between the male connector 26 at one terminal end 20 of the seal 12 and the female connector 28 formed at another end 22 of the seal 12. As shown at 212, the seal 12 is positioned over the shaft 14 thereby forming the interlocking fastening system connecting the terminal ends 20, 22 of the seal 12 with one another to provide detachable locking arrangement thereof in both radial and longitudinal directions and to prevent radial displacement and longitudinal uncoupling thereof.

As shown at 212, a sealant solution is applied about the seal 12 to completely seal mechanical connection 24 defined between the terminal ends 20, 22 thereby leaving no voids between the male and female connectors 26, 28. As shown at 214, all other components are assembled about the shaft 14, the outer surface 16.

FIG. 13 is a schematic view of the method of forming the seal of the present invention, generally shown at 300 to be discussed further below. As shown at 302, material such as any type of polyurethane material, an elastomeric material and polytetrafluoroethylene (PTFE) based materials, rubber, silicone, polyacrylic, fluoroelastomer, ethylene acrylic, hydrogenated nitrile or nitrile elastomer is placed into the extruder 70. As shown at 304, the extruder 70 forms the strand 78 of seal released from the extruder 70. As shown at 306, the controller 72 sends to the cutting tool 74 signal about predetermined length of the seal 12, number of the seals 12 to be formed, etc.

Alluding to the above, as shown at 308, the cutting tool 74 cuts predetermined number of pieces for each seal 12 with desired lock in profiles, such as, for example, “dovetail” profile, as shown in FIG. 1. As shown at 310, the seal 12 is assembled about the shaft 14 as the male and female connectors are locked with one another. As shown at 312, a sealant solution is applied about the seal 12 to completely seal mechanical connection 24 defined between the terminal ends 20, 22 thereby leaving no voids between the male and female connectors.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A seal for providing a sealing between a housing and a shaft having an outer surface and being rotatable around an axis and relative the housing, said seal comprising:
a body having terminal ends, an outer surface, extending generally parallel to the axis of the shaft and facing said outer object, a first flat surface and a second flat surface spaced by said outer surface and extending radially and generally perpendicular to the axis of the shaft, an inner surface extending in parallel to said outer surface; and
a dovetail mechanical connection defined on said outer surface extending generally parallel to the axis of the shaft and extending from said outer surface to said inner surface and generally perpendicular to the axis forming an interlocking fastening system connecting said terminal ends thereby providing a detachable locking arrangement thereof in both radial and longitudinal directions, said dovetail mechanical connection defined by a male connector and a female connector defined at said terminal ends preventing radial displacement and longitudinal uncoupling thereof.

2. The seal as set forth in claim 1, wherein said male connector includes a front wall extending beyond a front surface and pair of inclined side walls diverging from said front surface to said front wall to define a neck being shorter than said front wall.

3. The seal as set forth in claim 1, wherein said female connector is formed as a groove to receive said male connector as said female connector extends from said outer surface, extending generally parallel to the axis of the shaft to said inner surface to receive said male connector.

4. The seal as set forth in claim a, wherein said groove of said female connector includes a bottom wall to mate with said front wall of said male connector and a pair of inclined side walls converging from said bottom wall to mate with said inclined walls of said male connector.

5. The seal as set forth in claim 3, wherein said male connector is engagingly locked with said female connector at locking points thereby preventing any disengagement from one another providing locking arrangement thereof in both radial longitudinal directions.

6. The seal as set forth in claim 1, wherein said first flat surface extends beyond said second flat surface to a neck portion and further to an extension element extending generally parallel to the shaft, said extension element presenting an annular groove to receive a spring, a primary lip and a secondary lip to engage the shaft.

7. The seal as set forth in claim 1, wherein slid body of said seal is formed from at least one of polyurethane material, an elastomeric material and polytetrafluoroethylene (PTFE) based materials, rubber, silicone, polyacrylic, fluoroelastomer, ethylene acrylic, hydrogenated nitrile or nitrile elastomer.

8. A method of forming a seal to provide a sealing between a housing and a shaft having an outer surface and being rotatable around an axis and relative the housing, said method comprising the steps of:
operably connecting a controller, a seal forming device, and a cutting tool with one another;
placing an element into the seal forming machine to form a seal with predetermined and programmed dimensions and configurations send from the controller to the seal forming machine;
machining the element to have a cross section of body of the seal with an outer surface, a first flat surface and a second flat surface spaced by outer surface, an inner surface extending in parallel to said outer surface;
cutting the seal by the cutting tool whereby cutting profile extends through the outer surface to the inner surface to form a dovetail mechanical cut profile formed between a male connector at one terminal ends of the seal and a female connector at another end of the seal thereby forming an interlocking fastening system connecting the terminal ends of the seal with one another to provide a detachable locking arrangement thereof in both radial and longitudinal directions and to prevent radial displacement and longitudinal uncoupling thereof.

9. The method as set forth in claim 8, including the step of forming the cross section of the seal having a neck portion extending further to an extension element presenting an annular groove to receive a spring, a primary lip and a secondary lip to engage the shaft.

10. The method as set forth in claim 8, including the step of forming the male connector to include a front wall extending beyond a front surface and a pair of inclined side walls diverging from the front surface to the front wall to define a neck being shorter than the front wall.

11. The method as set forth in claim 8, including the step of forming the female connector with a groove to receive the male connector.

12. The method as set forth in claim 11, wherein the groove of the female connector is formed to have a bottom wall to mate with the front wall of the male connector and a pair of inclined side walls converging from the bottom wall to mate with the inclined walls of the male connector.

13. The method as set forth in claim 12, including the step of engagingly locking the male connector with the female connector at locking points hereby preventing any disengagement from one another and providing locking arrangement thereof in both radial and longitudinal directions.

14. The method as set forth in claim 8, wherein the step of pricing an element into the seal forming machine is further defined by placing a billet.

15. A seal for providing a sealing between a housing and a shaft having an outer surface and being rotatable around an axis and relative the housing, said seal comprising:
a body having terminal ends, an outer surface, extending generally parallel to the axis of the shaft and facing said outer object, a first flat surface and a second flat surface spaced by said outer surface and extending radially and generally perpendicular to the axis of the shaft, an inner surface extending in parallel to said outer surface, said first flat surface extending beyond said second flat surface to a neck portion and further to an extension element extending generally parallel to the shaft, said extension element presenting an annular groove to receive a spring, a primary lip and a secondary lip to engage the shaft;
a dovetail mechanical connection defined on said outer surface extending generally parallel to the axis of the shaft and extending from said outer surface to said inner surface and generally perpendicular to the axis forming an interlocking fastening system connecting said terminal ends thereby providing a detachable locking arrangement thereof in both radial and longitudinal directions, said dovetail mechanical connection defined by a male connector and a female connector defined at said terminal ends;
said male connector including a front wall extending beyond a front surface and a pair of inclined side walls diverging from said front surface to said front wall to define a neck being shorter than said front wall;
said female connector is formed as a groove to receive said male connector as said female connector extends from said outer surface, extending generally parallel to the axis of the shaft to said inner surface to receive said male connector, said female connector includes a bottom wall to mate with said front wall of said male connector and a pair of inclined side walls converging from said bottom wall to mate with said inclined walls of said male connector; and
said male connector being engagingly locked with said female connector at locking points thereby preventing any disengagement from one another providing locking arrangement thereof in both radial and longitudinal directions to further prevent radial displacement and longitudinal uncoupling thereof.
